(19) United States
(12) Patent Application Publication
(10) Pub. No.: US 2005/0228777 A1
(43) Pub. Date: Oct. 13, 2005

(54) Application interface for a data storage system

(75) Inventors: Geoffrey R. Kruse, Centennial, CO (US); Amy L. Ford, Elizabeth, CO (US)

Correspondence Address: MICROSOFT CORPORATION C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/814,828

(22) Filed: Mar. 31, 2004

(51) Int. Cl. G06F 17/30

(52) U.S. Cl. 707/3

(57) ABSTRACT

An application interface is used to retrieve information from a data storage system and in particular, for a financial/business system or general ledger system. Data from the data storage system is retrieved using a data mart that supports a generalized or system-independent format. The interface instantiates a detail interface identified in a field of the data mart to communicate with, or drill back to, the data storage system to retrieve detailed data such as detail transaction data through an interface.

### BACKGROUND OF THE INVENTION

The present invention relates generally to an application interface, and more particularly but not by limitation to an application interface compatible with data storage systems having diverse system formats or data structures.

Application programs, such as financial reporting programs, retrieve or access data, such as financial data, from a data storage system through an interface program. Data storage systems, such as financial or business systems, available from different vendors or origins have different data structures or formats and are not generally compatible with a standard interface. Thus, typically an application program will use an application interface that is configured or programmed to interface with one particular data storage system to communicate with, or retrieve data from, the particular data storage or financial/business system.

Alternatively data or information from data storage systems can be retrieved by converting the data to a generalized or system-independent data format using a data mart. Data is retrieved from the data mart using a generalized interface which is configured to retrieve data from the data mart to provide compatibility to diverse data storage systems. Use of a data mart to provide a generalized interface may obscure any type of direct access back to the date storage system. The present invention addresses these and other problems and provides solutions not previously recognized nor appreciated.

### SUMMARY OF THE INVENTION

The present invention relates to an application interface to retrieve information from a data storage system and in particular, a financial/business system or general ledger system. Data from the data storage system is retrieved using a data mart that supports a generalized or system independent format. The interface includes a detailed application interface to communicate with, or drill back to, the data storage system to retrieve detailed data such as detailed transaction data through an interface identified in a field of the data mart.

### BRIEF DESCRIPTION OF THE DRAWINGS

FIG. 1 is a block diagram of one illustrative environment in which the present invention can be used.

FIG. 2 is an illustration of an application interface to retrieve data from a data storage system of the prior art.

FIG. 3 illustrates an embodiment of a drilldown display for financial data.

FIG. 4 illustrates an embodiment of a drillback display to obtain detailed transaction data.

FIG. 5 illustrates an embodiment of a detail interface to drill back to a data storage or financial system to retrieve transaction or detailed data.

FIG. 6 illustrates an embodiment of an application interface to a data storage system using a data mart that supports a generalized, or data storage system-independent, data format.

FIG. 7 illustrates an embodiment of a data mart and conversion system to transform data to a generalized, or data storage system-independent, format.

FIG. 8 illustrates an embodiment of a drillback or detailed interface for a data storage system using a data mart as illustrated in FIG. 6.

### DETAILED DESCRIPTION OF ILLUSTRATIVE EMBODIMENTS

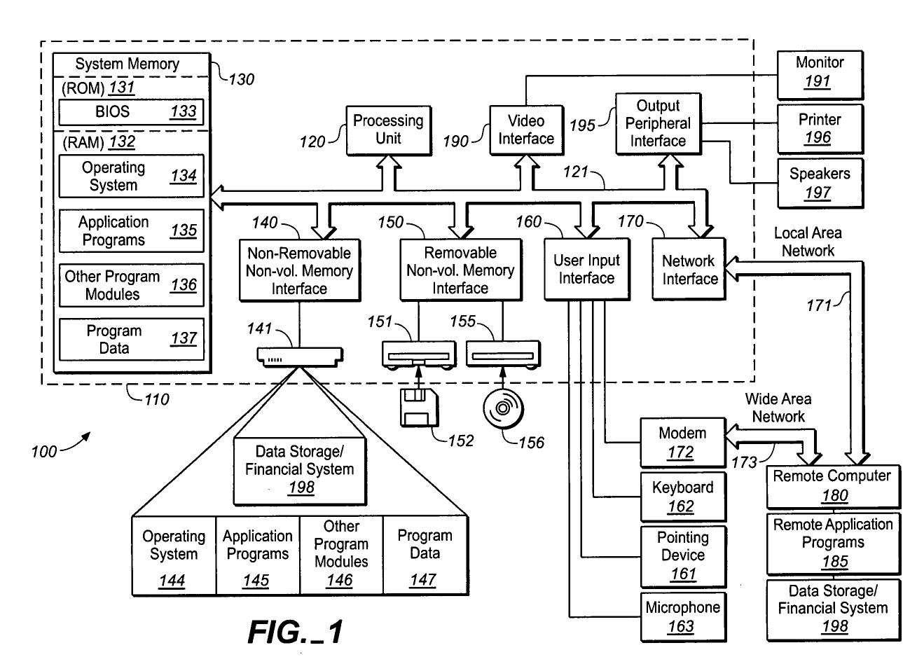

The present invention relates to an application or program interface to retrieve data from a data storage system for an application program and has application by way of example to a computing system environment 100 as illustrated in FIG. 1, although reference to FIG. 1 is by way of example and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110.

Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a generalized serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185, residing on remote computer 180 or local computer 110. It will be appreciated that the network connections shown are exemplary and other means of establishing a communications link between the computers may be used.

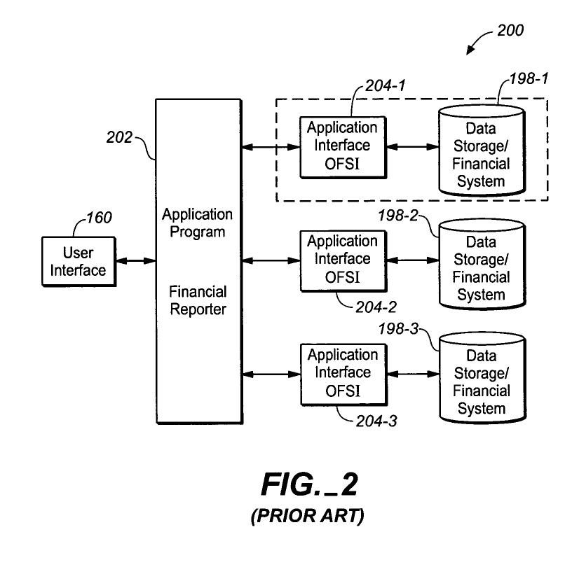

In one embodiment, the computer system environment 100 includes a data storage or financial/business system 198 stored on a hard disk drive 141 or alternatively on a remote computer 180 as shown to which the present invention has application although application is not limited to the particular embodiment shown. FIG. 2 shows a system in accordance with the prior art for accessing financial data. As shown in FIG. 2 computing system 200 includes an application program 202, such as a financial reporting program, which interfaces with a data storage system such as financial or general ledger systems 198-1, 198-2 or 198-3 available from different vendors or sources. The application program 202 interfaces with data storage system 198-1, 198-2 or 198-3 through an application specific interface such as 204-1, 204-2, 204-3 depending upon the selected data storage system 198-1, 198-2 or 198-3 to retrieve data or information from the selected data storage system 198-1, 198-2 or 198-3. In particular, the application program 202 interfaces with commercially available financial or general ledger systems.

In one embodiment the data storage system 198-1, 198-2 or 198-3 includes financial data or information which is accessed through an interface such as an Open Financial System Interface (OFSI) typically activated through a user interface 160, such as, but not limited to a keyboard 162, point device 161 or microphone 163 (as shown in FIG. 1). Different data storage systems have different data structures or formats requiring an application specific interface or OFSI 204-1, 204-2 or 204-3 in order for the application program 202 to communicate with, and retrieve data from, the selected data storage system 198-1, 198-2 or 198-3 from a particular vendor.

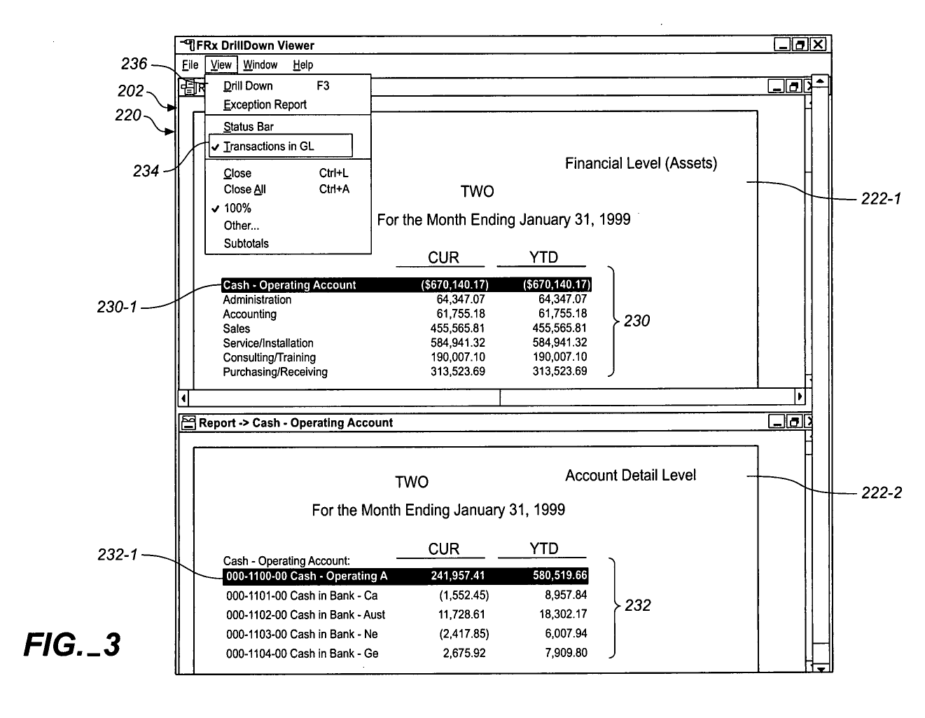

FIG. 3 is one embodiment of a display (or user interface 160) generated by program 202. In the embodiment shown in FIG. 3, the application program 202 is a financial reporting application which retrieves financial information or data from a financial system or general ledger system 198-1, 198-2 or 198-3 based upon user inputted queries. Program 202 then generates reports based upon retrieved data or information from the financial system or general ledger system 198-1, 198-2 or 198-3. In the embodiment illustrated in FIG. 3, the reporting application includes drilldown viewer 220 which includes associated executable code to generate or run reports on financial and/or account detail. The report feature of the reporting application 202 is activated from the drilldown viewer 220 through user interface 160, such as with a pointing device 161 (not shown in FIG. 3).

In the illustrated embodiment, the drilldown viewer 220 includes a financial level report display 222-1 which can be outputted to an output device such as a monitor 191 or printer 196 as previously shown in FIG. 1. The drilldown viewer 220 includes a drilldown feature which generates an account level report display 222-2 corresponding to a selected financial line item, such as 230-1 of the financial level report display 222-1. The account level report display 222-1 is activated (for example) by double clicking on a selected financial line item 230 using a pointing device 161. The account level report display 222-2 displays account entries 232 corresponding to the selected financial line item 230-1 of the financial level report 222-1.

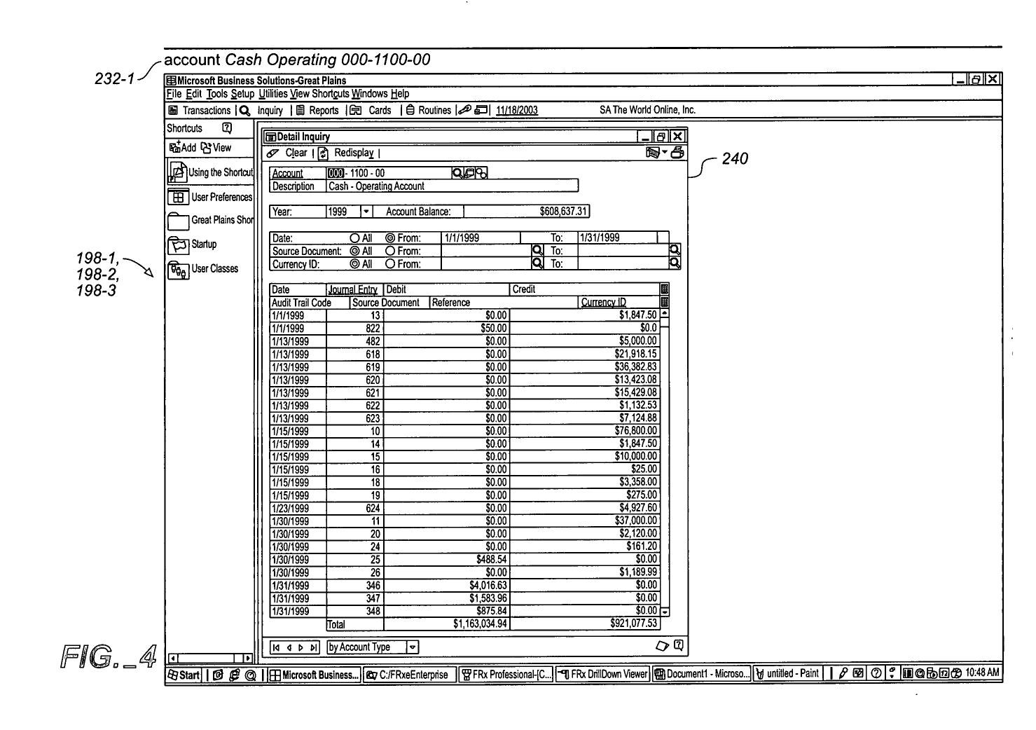

Prior applications or reporting programs support a detail or transaction drilldown feature to retrieve transaction data from the open financial or data storage system 198-1, 198-2 or 198-3 used to generate the account entries 232 on the account level report 222-2. The detail or transaction drilldown feature is activated by selecting “Transactions in GL” or similar instruction 234 from a drilldown viewer menu 236. The drilldown feature is activated to retrieve transaction data for a selected account entry, such as 232-1. The account entry is selected by double clicking on the account entry 232-1 for 000-1100-00 Cash-Operating A 232-1 as illustrated in FIG. 3 using the pointing device 161 (not shown in FIG. 3). The drilldown viewer then drills back to the open data storage system 198-1, 198-2 or 198-3 to retrieve detail transaction data 240 from the data storage system for the selected account 232-1. One display showing such detail transaction data is illustrated in FIG. 4. As shown, such detail transaction data 240 shows detailed, individual transactions that support the line item selected in FIG. 3.

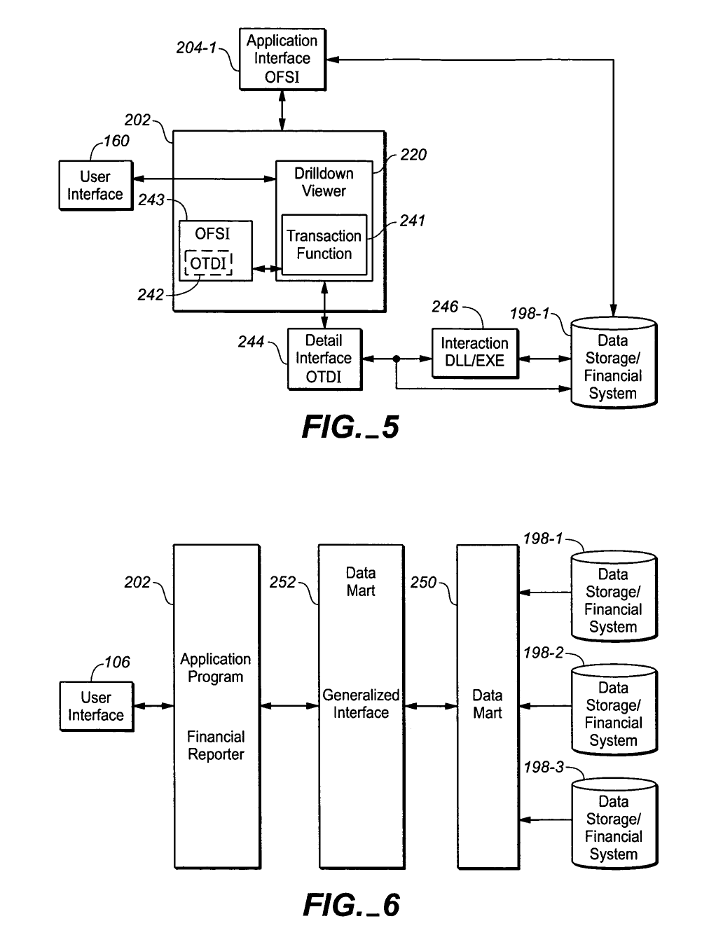

FIG. 5 illustrates in more detail how the drill back to the detail transaction data occurs in accordance with the prior art. As illustrated in FIG. 5, upon activation of the transaction drilldown feature, a drilldown view component or Drill Transaction Function 241 retrieves a detail interface identity or the identity 242 of the Open Transaction Detail Interface (OTDI) 244 from a table or database 243 corresponding to the OFSI for the active financial or data storage system which in the illustrated embodiment is data storage system 198-1. The retrieved interface identity 242 is used to call or instantiate the detail interface or OTDI 244 to drill back to the open financial or data storage system 198-1 to display or retrieve the requested transaction data as illustrated in FIG. 5.

In particular, as illustrated in FIG. 5, in one embodiment, the detail interface 244 communicates directly with the financial or data storage system 198-1 or alternatively, the interface 244 retrieves the transaction data 240 from the financial or data storage system 198-1 through an interaction object 246. In particular, some financial system or general ledger vendors expose their object model and in such cases the reporting application 202 includes an interface 244 that can directly access the active financial or data storage system 198-1, and in other cases, the interaction object 246 is needed to drillback to the open financial or data storage system 198-1 as illustrated in FIG. 5.

In an illustrated embodiment, the detail interface OTDI 244 invokes a “Transaction Detail Posted Information Screen” to display transactions for the posted account data 232-1 using or invoking a screen display of the application or financial system program 198-1, 198-2 or 198-3. To use the transaction drilldown feature the data storage or financial system 198-1 must be open or running in the background.

It is desireable that the reporting or application program 202 be compatible with different financial programs or data storage systems with diverse formats and data structures. As previously discussed, to interface with different data storage systems, a specific application interface that is compatible with or configured to communicate or interface with each data storage system is required. Creation of specific application interfaces to communicate or interface with all the data storage systems available on the market is burdensome, limiting compatibility of the reporting or application program 202.

In one embodiment shown in FIG. 6, the application program 202 communicates with diverse data storage systems 198-1, 198-2 or 198-3 using a data mart (such as a financial data mart FDM) 250 that supports a generalized or data storage independent data format for compatibility with a plurality of data storage systems 198-1, 198-2 and 198-3 having diverse system formats. As shown in FIG. 6, the application program 202 communicates with the data mart 250 via a generalized application interface 252 to retrieve data or information from an open financial or general ledger system 198-1, 198-2, or 198-3 through user interface 106.

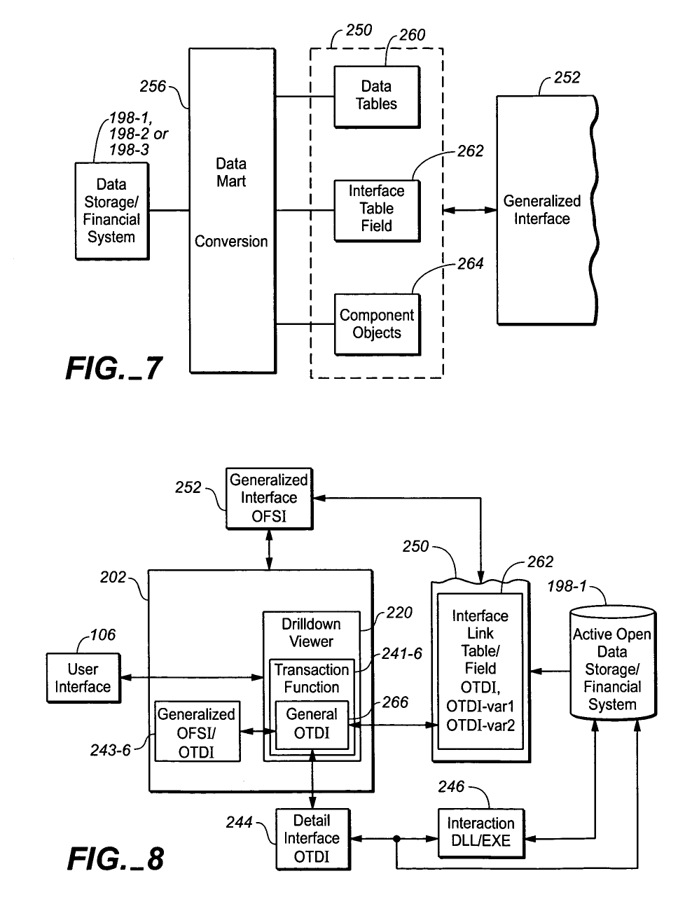

In particular as illustrated in FIG. 7, data or information from the data storage or financial system 198-1, 198-2 or 198-3 is converted into a generalized or system-independent data format via a conversion program or module 256 and is stored in a data table 260 of the financial data mart 250. As previously discussed in prior applications or programs the drilldown viewer 220 includes a drill back feature to retrieve detail information directly from an open data storage or financial system 198-1, 198-2 or 198-3. In the generalized system of FIGS. 6-7, the link to the detail interface is somewhat obscured since the reporting or application program 202 interfaces with the data storage system using a data mart 250 which supports interface to multiple systems.

The present invention relates to an interface algorithm or system to retrieve detailed transaction data from a financial or data storage system 198-1, 198-2 or 198-3 which is compatible with a plurality of systems using a data mart 250 that supports a generalized or data storage-independent data format. In one embodiment as shown in FIG. 7, the data mart 250 includes an interface table or field 262. The table or field holds an identifier of a detail interface 244 to be used to obtain detail transaction information from an associated financial system 198. The identifier is illustratively passed from the system 198 to the table 262 in data mart 250 by financial system 198 at any time prior to data access from financial system 198. This table or field can take any desired form and can have any desired name. Also, while it is described as a table it could be another data storage structure as well. One structure and naming scheme is discussed herein for the sake of example only. In an illustrative embodiment, the interface table is referred to as frl_entity table. In the illustrated embodiment, the table (e.g. frl_entity table) 262 includes a OTDI identifier (e.g. such as location of a detail interface 244) and OTDI_var1 and OTDI_var2 variable fields. The OTDI identity field is illustratively a string, and the variable fields can store other desired information to identify the detail interface 244.

To drill back to the detail transaction data in open financial system 198-1, the drill down transaction function 234 is activated from menu 236 in the drilldown viewer 220. Upon activation of the transaction drilldown function 234, as illustrated in FIG. 8, the drilldown transaction component 241-6 instantiates and invokes a generalized drilldown interface object (for example OTDIWrapper.dll-direct link library) 266 corresponding to the generalized interface 252 from a datatable or database 243-6. The generalized drilldown interface object 266 communicates with the data mart 250 to retrieve the particular detail interface 244 based on the identifier (name or link) for the open financial system which in the embodiment illustrated in FIG. 8 is 198-1. In a particular embodiment, the drilldown interface object or OTDIWrapper.dll 266 uses the information passed into the Drill Transaction function 241-6 (e.g. ρEntity Information Parameter for example) to create connection to the data mart 250 to retrieve the detail interface or OTDI identifier from the field (e.g., the frl_entity table) 262.

The drilldown interface object 266 then creates an instance of the detail interface 244 or direct link library (DLL) specified in the OTDI field 262. Object 266 then passes the instantiated interface 244 information identifying a particular line item in display 222-1 (FIG. 3) for which detailed transaction data is to be retrieved. The information is illustratively received from the drilldown viewer object 222 and includes, for instance, Entity Information, Vendor System ID, Mask Account Code, Unmasked Account Code, Account Mask, Account ID, Balance Filters and Unload Flag or other information, and variables, such as OTD_var1, OTD_var 2 associated with the created interface object 244 to retrieve the transaction data 240 as previously described relative to FIG. 5. The variables (such as OTD_var1, OTD_var 2) can be any variables that the particular data storage or financial system needs to identify where the transaction data 240 is stored.

If the OTDI identity field 262 is empty, then the reporting program does not support a transaction drillback feature or interface and the transaction data 240 is not displayed.

Thus, as described, the drill transaction function provides detail transaction data from account level reports without running additional reports in the application or reporting program to obtain the transaction detail.

Although the present invention has been described with reference to particular embodiments, workers skilled in the art will recognize that changes may be made in form and detail without departing from the spirit and scope of the invention.

1. A system for retrieving financial information from a financial data storage system, comprising:
an application interface configured to return requested detail information to an application program by accessing detail interface information in a data mart that stores the detail interface information for a plurality of detail interfaces, and to instantiate and invoke a detail interface based on the detail interface information to obtain the requested detail information.

2. The system of claim 1 and further comprising the detail interface operable to retrieve requested detail information from the financial data storage system.

3. The system of claim 1 wherein the application interface is configured to retrieve financial data from a financial system or general ledger system using the data mart.

4. The system of claim 3 wherein the application program is a reporting program configured to retrieve data to generate financial or account detail reports.

5. The system of claim 2 wherein the application interface is configured to retrieve transaction data for an account entry in the application through the detail interface identified by the detail interface information.

6. The system of claim 1 wherein the data mart includes a data field to store the detail interface information.

7. The system of claim 1 wherein the application interface is configured to receive an activation from a drilldown viewer in the application program.

8. The system of claim 1 wherein the detail information comprises detailed transaction data.

9. The system of claim 8 wherein the application interface is configured to receive a selected account entry for which to retrieve the detail transaction data.

10. A method of displaying financial data stored in one of a plurality of financial data storage systems, comprising:
receiving a detail information request from an application;
retrieving detail interface information from a data mart;
instantiating a detail interface identified by the detail interface information;
retrieving the detail information requested from one of the financial data storage systems through the instantiated detail interface; and
returning the detail information to the application.

11. The method of claim 10 wherein the financial data storage system comprises a general ledger system and retrieving the detail information comprises retrieving data from the general ledger system.

12. The method of claim 10 wherein retrieving the detail information comprises:
receiving identity information indicative of the requested detail information from the application.

13. The method of claim 12 wherein retrieving the detail information comprises:
invoking the detail interface using the identity information to retrieve the requested detail information.

14. The method of claim 13 wherein the detail identity information comprises selected account information.

15. The method of claim 10 wherein receiving a detail information request comprises:
receiving an input from a drilldown viewer of an application program.

16. A drilldown system used by an application program on a computer readable medium having a drilldown feature activatable to display transaction data from an open business system, comprising:
a drilldown interface to a data mart that stores detail interface information identifying a detail interface used to obtain detail information from the open business system.

17. The drilldown system of claim 16 wherein the drilldown interface is configured to instantiate the detail interface based on the interface information.

18. The drilldown system of claim 17 wherein the drilldown interface is configured to invoke the detail interface to retrieve detail information.

19. The drilldown system of claim 18 wherein the detail information comprises detailed transaction data supporting a line item in a report displayed by the application program.
